(19) United States
(12) Patent Application Publication
(10) Pub. No.: US 2005/0126880 A1
(43) Pub. Date: Jun. 16, 2005

(54) Counter/tabletop alignment note feeder

(76) Inventors: Richard J. Iannello, Sebastopol, CA (US); James K. Bullock, Las Vegas, NV (US); Gwen D. Mathis, Las Vegas, NV (US)

Correspondence Address: David B. Abel, Esq.;Squire, Sanders & Dempsey, L.L.P., 14th Floor, 801 S. Figueroa Street, Los Angeles, CA, 90017, US

(21) Appl. No.: 10/958,958

(22) Filed: Oct. 4, 2004

Related U.S. Application Data
(63) Continuation-in-part of application No. 10/863,059, filed on Jun. 7, 2004.
Application No. 10/863,059 is a continuation of application No. 10/081,756, filed on Feb. 20, 2002, now Pat. No. 6,745,887.

(51) Int. Cl. G07F 7/04

(52) U.S. Cl. 194/206

(57) ABSTRACT

A bill acceptor assembly for accepting bills, vouchers, scrip, tickets and/or currency at a gaming table. The bill acceptor assembly includes a bulk note feeder capable of accepting a stack of individual notes and coupled to a validator assembly. The bulk note feeder includes a mouth opening to receive a stack of notes and an escrow reservoir for storing the stack of notes until they are fed into the validator assembly.

### RELATED APPLICATIONS

This application is a Continuation In Part of U.S. application Ser. No. 10/863,059, filed on Jun. 7, 2004 which is a Continuation of U.S. application Ser. No. 10/081,756, filed Feb. 20, 2002, entitled Gaming Table Validator Assembly, now U.S. Pat. No. 6,745,887, and hereby incorporated by reference.

### BACKGROUND OF THE INVENTION

1. Field of Invention

This invention is directed to a note feeder adapted to receive one or more notes from the top side of a table and provide the notes to a validator assembly located underneath the table. In particular, the bulk note feeder is adapted to provide each of the notes to the validator assembly along a predetermined orientation.

2. General Background and State of the Art

Conventional gaming tables located in casinos are generally used to play games such as blackjack, poker, roulette, baccarat, and craps. The table may have an outer periphery containing a plurality of player locations and a dealer's location located generally opposite the player locations. From the dealer's location, the dealer controls the pace and operation of the game including for example dealing the cards, paying winning wagers and collecting losing wagers.

A dealer's responsibilities also include exchanging currency or notes received from a player for casino chips. Generally, when a player wants to exchange currency or notes for chips at the gaming table, the player gives the currency or notes to the dealer. Notes, as used herein, can include local and foreign currency, casino scrip, and casino issued tickets. The dealer counts out and then spreads the currency or notes on the playing surface of the gaming table. The dealer is sometimes required to notify a Pit Boss that the dealer is exchanging currency or notes. After receiving an approval from the Pit Boss, the dealer accepts the currency or notes and deposits them into a slot accessible from the playing surface of the gaming table. The slot leads to a channel for transporting the currency or notes from the slot to a cash box located below the playing surface. A plate may be used to push the currency or notes into the slot and ensure that the currency or notes properly fall into the cash box.

The revenues received on the gaming tables are a significant source of income for a casino. Accordingly, the high volume of currency or notes exchanged invites the risks of receiving counterfeit currency or notes. Unlike slot machines, wherein the implementation of integrated bill acceptors in the slot machines has diminished the casinos' risk of receiving counterfeit currency, most gaming tables remain susceptible to this risk. Due to the increased sophistication of counterfeiters and the increasing difficulties in discriminating between authentic and counterfeit currency, the manual or dealer inspection method of accepting currency on gaming tables is inadequate to protect casinos from currency fraud. Also, as the use of casino scrip and casino tickets increases, there is a risk that these forms of revenue could be compromised or counterfeited. Accurate accounting of these alternative forms of notes may require that they be validated upon receipt.

A few attempts have been made to patent the use of a bill acceptor assembly on electronic gaming tables. For example, U.S. Pat. No. 5,775,993 (“the '993 patent”) issued to Fentz et al. discloses a bill acceptor assembly mounted at each player station located around an electronic roulette wheel. Similarly, in U.S. Pat. No. 5,588,650 (“the '650 patent”), each player console located around an automated roulette wheel includes a bill acceptor. In both of these patents an individual as opposed to a computer directs the game. A player can insert money into the bill acceptor to earn credits at any time, even though the player may not be able to place a bet until the next betting period. Yet, both the '993 patent and the '650 patent have two fundamental flaws. First, both patents use traditional single-feed bill acceptors where the player must insert one note at a time into the bill acceptor. The bill acceptors in the '993 patent and the '650 patent are not designed to accept multiple notes at one time. At a gaming table, players may start their betting with a large sum of money which, in the configuration of the '993 or '650 patents, would require each player to feed each note one at a time into the bill acceptor. The effort involved in feeding each note can be time consuming and frustrating, and even more so if the bill acceptor does not accept every note on the first feeding attempt.

Second, incorporating a bill acceptor into a computerized gaming table does not involve the same difficulties as incorporating a bill acceptor into a conventional gaming table operated by an individual. On the computerized gaming table, a computer using pre-programmed software manages each player's credits, operates the game, calculates and pays out all winnings, and collects any losing wagers. No casino tokens or notes are dispensed until a player cashes out. On the other hand, a gaming table operator has to do all of the functions by himself or herself. In addition, the operator is given the responsibility of watching each player to ensure that he/she does not cheat. Neither the '993 patent nor the '650 patent explain or address the many concerns of how to incorporate the bill acceptor into a gaming table operated by an individual. For example, neither patent discloses how the operator would know how much money has been inserted into the bill acceptor. This disconnect in information would prevent the operator from knowing how many tokens to give back to the player.

Accordingly, a system for accepting valid currency and rejecting counterfeit currency on a conventional gaming table would be beneficial to the gaming industry. Such a system would increase the casino's profitability by decreasing the amount of counterfeit currency it may receive. Moreover, a bill acceptor capable of accepting and validating a stack of notes would significantly decrease the delay involved in feeding one note at a time into the bill acceptor.

Modern day cash exchange transactions have become much more efficient with the invention of automated bill acceptors as described previously. In general, bill acceptors have increased the efficiency, accuracy and reliability of the intake of money for such transactions. Bill acceptors are now utilized in a variety of different forums, including parking booths, toll booths, vending machines and, more recently, gambling venues.

As described previously, a dealer in the gaming industry has a multitude of tasks to oversee while conducting his/her job. An important aspect of a dealer's job is to insure that the notes received by players are properly dispensed through a slot to the cash box typically located beneath the gaming table. In some instances, automated bill acceptors are provided with gaming tables to receive and store the notes. Even with automated bill acceptors, however, the dealer is still responsible for insuring that the notes from the players enter into the bill acceptor. Inserting the notes into the bill acceptor can be distractive to the dealer such that the dealer is unable to adequately monitor the gaming table while inserting the notes into the bill acceptor. Accordingly, there still is a need for a device which will allow the dealer to insert notes into a bill acceptor without causing distraction to him/her.

### SUMMARY OF THE INVENTION

This invention is directed to a bulk note feeder adapted to accept a stack of indiscriminate notes to be ultimately authenticated and stacked by a bill acceptor and cash box. Due to the expansion of the types of currency and currency substitutes which are accepted by current bill acceptors, bills, vouchers, script, tickets and currency will be hereinafter collectively referred to as “notes.” The bulk note feeder of the present invention provides a bezel having a mouth adapted to receive at least one note, a reservoir to temporarily store the notes received through the mouth, and a transportation system capable of passing the notes from the reservoir to a validator assembly. The reservoir may temporarily store the notes in a predetermined orientation so that the transportation device may pass each of the notes from the reservoir along a predetermined pathway towards the validator assembly.

The mouth of the bezel of the note feeder may have a rectangular configuration wide enough to receive notes inserted elongated edge first. The bezel is designed to be mounted on a planar surface, such as a gaming table. At least a portion of the bezel surrounding the mouth may be provided with a lip that protrudes up from the surface of the table to prevent accidentally spilled liquids from entering the mouth. Additionally, the lip may be configured so that the operator or dealer may locate the mouth by touch.

When a stack of notes is inserted into the mouth of the bezel, the notes travel down a cash chute to a holding reservoir. The holding reservoir is located at the base of the cash chute to temporarily store the notes until they are passed to a validator assembly. From the temporary holding reservoir, the stack of notes are passed to the validator assembly through the operation of a transportation system such as an electromechanical or, pneumatic transport mechanism. The transportation system passes one note at a time to the validator assembly located underneath the table.

The bulk note feeder may be provided with a gate or valve that closes the cash chute for a period of time after a stack of notes has been dropped into the mouth. The valve allows a first stack of notes to pass through the cash chute and to the validator assembly before allowing a second stack of notes from being accepted through the mouth so that the second stack of notes are not intermixed with the first stack of notes. The valve thus allows each stack of notes sufficient time to pass through the cash chute before accepting another stack of notes through the mouth.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a perspective view of a gaming table with an installed bill acceptor.

FIG. 2 is a representative cross sectional view of the bill acceptor and a cash box assembly.

FIG. 3 is a perspective of a mounting bracket for mounting the bill acceptor to the gaming table.

FIG. 4 is a perspective view of a cashbox housing and power assembly of the bill acceptor.

FIG. 5 is a perspective view of an alternative configuration for a bill acceptor and a bill guard installed on a gaming table.

FIG. 6 is a perspective view of another alternative embodiment of a bill acceptor for mounting on a gaming table.

FIG. 7 is a perspective view of an alternative note feeder and transportation system.

FIG. 8 is a cross sectional view of the note feeder illustrated in FIG. 7.

FIG. 9 is a partial exploded view of certain components of the note feeder and the transportation system illustrated in FIG. 7.

FIG. 10 is a second exploded view of certain components of the transportation system illustrated in FIG. 7.

FIG. 11 is a perspective cutaway view of certain components of the transportation system of FIG. 7.

### DETAILED DESCRIPTION OF PREFERRED EMBODIMENTS OF THE INVENTION

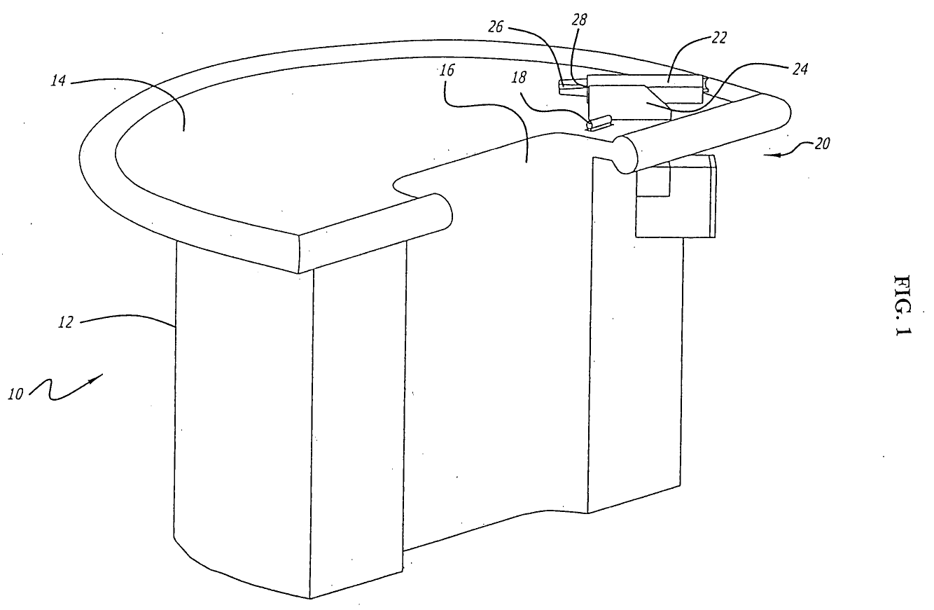

FIG. 1 provides a perspective view of a gaming table 10 having a base 12 and a playing surface 14. The gaming table 10 has a dealer station 16 opposed by semi-circularly arranged player positions. The gaming table 10 will normally have a drop slot 18, positioned proximate the dealer station 16, which defines a hole in the gaming table 10 and allows for notes to be deposited into a cash box contained proximate the base 12, or within the base. While a card type gaming table is depicted, the invention is applicable to other types of gaming tables.

As further illustrated in the exemplary embodiment of FIG. 1, a bill acceptor 2G is positioned on the playing surface 14 of the gaming table 10. The bill acceptor 20 includes a housing 22 and a mounting bracket 24 to secure the housing 22 to the gaming table 10. The housing 22 includes a bezel 26 upon which notes can be stacked and sequentially fed through a slot 28 into the bill acceptor 20. The slot 28 generally comprises an opening dimensioned to receive the notes.

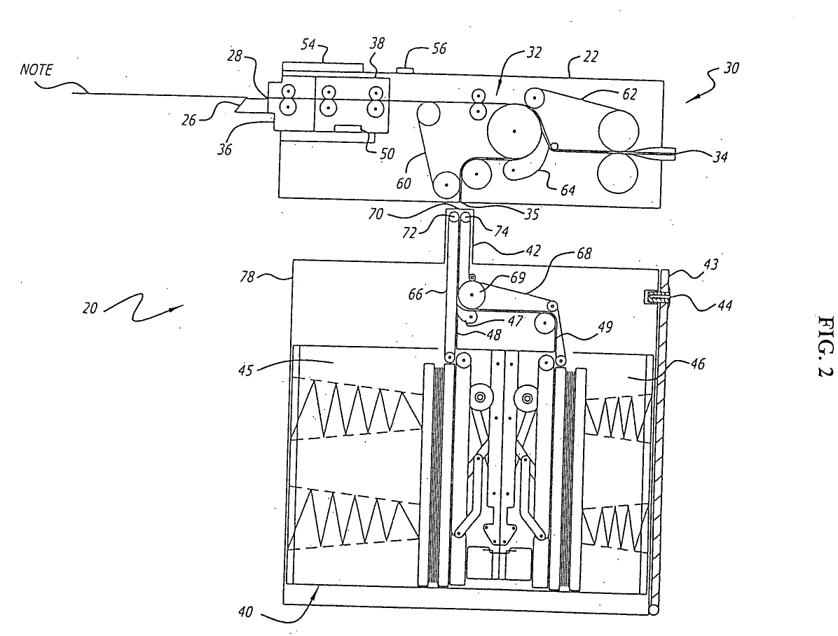

FIG. 2 depicts a cross-sectional view of the bill acceptor 20 and an associated cash box 40 removed from the gaming table 10 of FIG. 1. Within the bill acceptor 20, the notes are transported through a validator assembly 30 by a transportation assembly 32, as discussed below. A bill separator 36 may be located proximate the slot 28. The notes pass from the bill separator 36 through a bill discriminator 38 to determine if the notes are authentic. The bill acceptor 20 also includes, at an opposite end of the housing 22, a bill dispenser slot 34. In the event that the bill discriminator 38 determines that a note inserted into the validator assembly 30 is not authentic, the transportation assembly 32 passes the note through the housing 22 to the bill dispenser slot 34.

As illustrated, notes are to be inserted into the bill acceptor 20 through the slot 28. Notes rejected by the validator assembly 30 are ejected through the bill dispenser slot 34. Valid notes are deflected downward through a slot 35 located on the underside of the housing 22 which is to be positioned over the drop slot 18 of the gaming table 10. In an alternative embodiment, the notes are directed to a location along the back edge of the gaming table 10 to then be transported to the cash box 40.

A power assembly 42 draws the valid notes away from the validator assembly 30 and deposits them into the cash box 40, which is to be mounted below the playing surface 14 of the gaming table 10. The power assembly 42 also supplies power to and exchanges information with the validator assembly 30 through a power connector located on the underside of the housing 22 as discussed below. The cash box 40 is contained within a cash box housing 78 having a cash box door 43 and a door lock 44 to prevent unauthorized access to the contents of the cash box 40. The cash box 40 may simply be an open container having a slot in the top through which the notes are inserted. As depicted in FIG. 2 the cash box 40 receives and stacks the notes. While the cash box 40 may have a single stacker for all of the notes, it may be preferable to have two stacker sections as depicted, wherein first stacker section 45 receives and neatly stacks currency. A second stacker 46 can be used to stack a selected currency denomination or alternatively all non-currency notes accepted by the bill acceptor. As another alternative, the second stacker 46 could be used to store “fill slips” signifying additional chips being brought to the gaming table. Thus, the second stacker 46 could be used to store all documents, or all non-currency items, received by the bill acceptor. Accordingly, for this dual stacker cash box, the power assembly 42 will have a transport system and a deflector 47 to allow the notes to be directed to the appropriate stacker along a first transport path 48 or a second transport path 49.

The validator assembly 30 contains a circuit board mounted validator processor 50 which is also preferably connected to a central computer or server (not shown) of the casino. The validator processor 50 has various processing capabilities which are known in the art. Upon receipt of a note and determination of validity, a signal is sent to the casino processor or server signifying receipt as well as the denomination of the note. The value of the notes accepted by the validator assembly 30 can then be displayed on an LCD display 54.

There may be situations where some or all of the notes received are rejected from the validator assembly 30 even though it may be apparent to the dealer that the rejected notes are authentic. In this and other situations, the dealer may want to accept the notes in spite of the refusal of the validator assembly 30. To override the decision of the validator assembly 30, the dealer could activate an override input, such as an Accept button 56 which is electrically connected (not shown) to the validator processor 50. Pressing the Accept button 56 will force the validator assembly 30 to accept the notes and the transportation assembly 32 to transport the notes to the cash box 40. Software associated with the bill acceptor 20 can be provided to keep track of the number of notes received as a result of the dealer overriding the validator assembly 30.

If a player wants to place a bet with a dealer operating a casino game on the gaming table 10, casinos generally require the player to use the casino's own tokens to play. The player may already have casino tokens in possession or may give notes to the dealer who will exchange the notes for an equivalent value of casino tokens. To validate the notes received from the player, the dealer or player places the stack of notes on the bezel 26. The bill separator 36 pulls off one note at a time through the slot 28. The technology of bill separators is known in the art, which includes feeding devices such as printers, photocopiers, currency counters, and automated teller machines that feed one sheet of paper, such as a note, from a stack of paper or notes.

The notes are then pulled into the bill discriminator 38 by the transportation assembly 32. Because they are electrically connected to one another, the bill discriminator 38 can instruct the transportation assembly 32 to direct and transport validated notes into the cash box 40 and invalid notes to the bill dispenser slot 34. The transportation assembly 32 includes belts 60 and 62 that transport the note from the bill discriminator 38 to the deflector 64. Depending on the authenticity of the note processed, the bill discriminator 38 will send a signal to a deflector 64 which directs the pathway of the note through the validator assembly 30. If the note is authentic, the deflector 64 will remain in an initial position to direct the notes downwards towards the cash box 40. In the event the note is not authentic according to the bill discriminator 38, the deflector 64 moves from the initial position to a secondary position to deflect the note to an exit or horizontal pathway out of validator assembly 30.

It is understood that the transportation assembly 32 discussed above is an exemplary embodiment for illustration purposes only. Other transportation systems well known or apparent to one skilled in the art are to be included within the scope of the present invention. In addition, in an alternative embodiment, the slot 28 and the bill dispenser slot 34 may be the same.

As illustrated in the cross-sectional view of FIG. 2, the transportation assembly 32 transports valid notes past the deflector 64 to slot 35, which is positioned opposite a narrow extension of the power assembly 42, configured to extend up through the drop slot 18 of the gaming table 10. At the top of the narrow extension is a slit 70 into which the notes are directed. After entering the slit 70, the note passes between two wheels 72 and 74, driven by belts 66 and 68, respectively which draw the note down towards the cash box 40 and away from the validator assembly 30. The belt 66 extends down to the top of the cash box 40 to direct notes to the first stacker 45 of the cash box 40 if a deflector 47 is in an initial position according to the type of note. Belt 68, driven by a motor drive 69 and passing over or around various idler wheels, drives belt 66 and controls the direction of notes directed to the second stacker 46 of the cash box 40 if the deflector 47 moves to a second position.

The bill acceptor 20 may be composed of multiple modules that facilitate installation on a gaming table 10, including for example the mounting bracket 24, the validator assembly 30, and the cash box housing 78 which contain the power assembly 42 as well as the cash box 40. The validator assembly 30 can be an independent component and compact assembly, for example, about the width and length of two U.S. currency bills placed consecutively lengthwise. The mounting bracket 24 is adapted to receive and securely hold the validator assembly 30 to the gaming table 10.

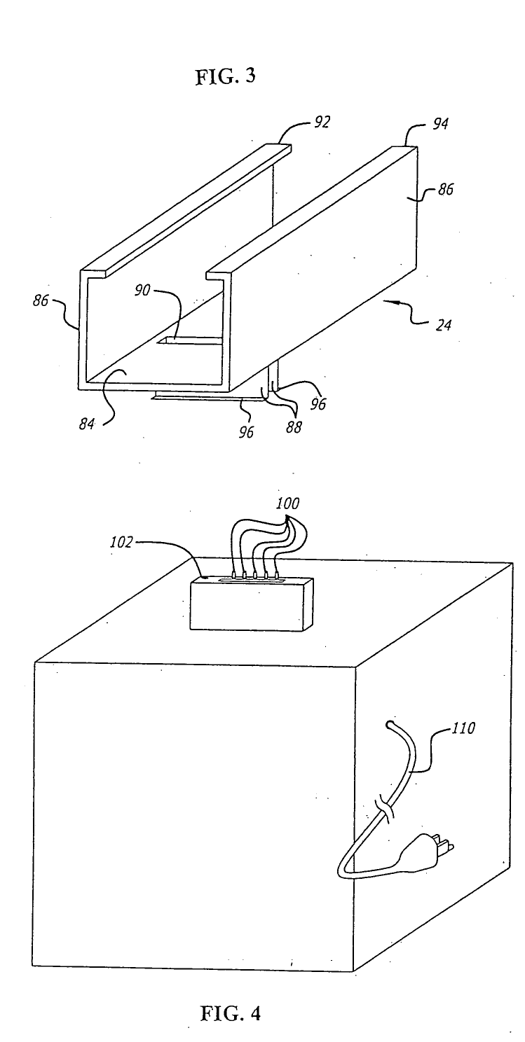

As illustrated in FIG. 3, the mounting bracket 24 may have a base plate 84 that is connected to two plates 86 extending upward and two plates 88 extending downward. The base plate 84 has an opening 90 that is similar in size to the opening of the drop slot 18. The upward plates 86, which rise upward from the base plate 84 and contain overhangs 92 and 94, secure the validator assembly 30 from the top, underside, and each side parallel to the length of the validator assembly 30. A locking mechanism may be provided on the validator assembly 30 so that it can mate and lock with a lock receiver to secure the validator assembly 30 to the mounting bracket 24.

The plates 88, which extend downward from the base plate 84, are parallel to the wider wall of the drop slot 18. The lower ends of the plates 88 extend down the full length of the drop slot 18. At the lower end, the plates 86 may include flanges. 96 that clip to the underside of the gaming table 10. To install the mounting bracket 24, the plates 88 are inserted into and pushed through the drop slot 18. After the flanges 96 extend past the end of the drop slot 18, the flanges 96 grip onto the gaming table 10, preventing the removal of the mounting bracket 24. To remove the mounting bracket 24 from the gaming table 10, the flanges 96 must be squeezed together from below the gaming table 10.

As illustrated in FIG. 4, the top of the narrow extension of the power assembly 42 includes a plurality of pin contacts 100 located extending from the power assembly 42 toward the validator assembly 30. The pin contacts 100 may be spring-loaded to maximize contact between the pin contacts 100 and contacts located on the base of the validator assembly 30. The pin contacts 100 and contacts on the validator assembly 30 are made of alloys that allow transfer of electrical power and data between the validator assembly 30 and the power assembly 42. Alternatively, pin contacts 100 may be used primarily to transfer power from the power assembly 42 to the validator assembly 30, whereas an optical coupling device 102 on the power assembly 42 communicates with an optical coupling device on the validator assembly 30 to transfer data information.

The pin contacts 100 are attached to a power supply and controller in the power assembly 42. A cable 110 can be provided to couple power to the power assembly 42 and also electrically couple the controller of the power supply 42 to a computer server (not shown) in the casino. Alternatively, wireless technology can be used to communicate information between the bill acceptor 20 and a computer server (not shown) in the casino.

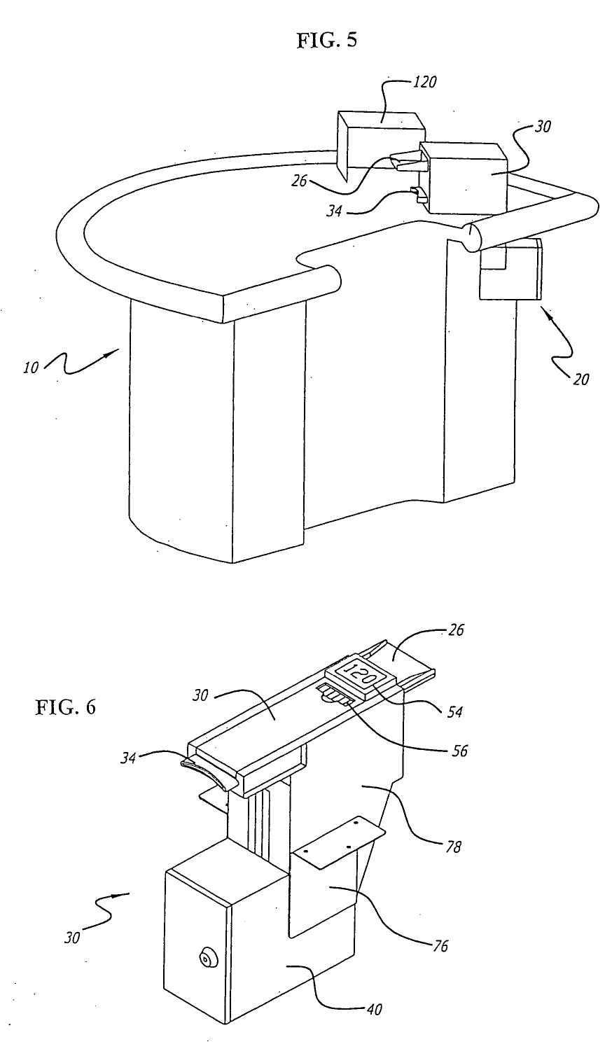

As illustrated in FIG. 5, a bill guard 120 attaches to the gaming table 10 and is positioned near the bill acceptor 20. The bill guard 120 minimizes the possibility that a player could reach onto the gaming table and remove the notes as they were being fed into or rejected from the bill acceptor. The bill guard 120 can be made of a translucent material such as high impact plastic. The bill guard 120 will allow the dealer and players to watch the bills as they are inserted into or rejected from the validator assembly 30. The bill acceptor 20 depicted in FIG. 5 is an alternative embodiment, where the bezel 26 and the bill dispenser 34 are positioned on the same side of the validator assembly 30.

As depicted in an alternative embodiment in FIG. 6, the bill acceptor 20 is enclosed within an integrated housing 78 containing the cash box 40. To install the bill acceptor 20 on the gaming table 10, a hole is cut into the gaming table 10. The hole may need to be larger than the drop slot 18. The bill acceptor 20 is mounted through this hole such that the validator assembly 30 is above the playing surface 14 and the cash box 40 is below. Mounting members 76 are provided to secure the bill acceptor 30 to the gaming table 10. The internal components of the bill acceptor 30 in the exemplary embodiment, such as the transportation assembly 32, bill separator 36, and the bill discriminator 38, would be used in this alternative embodiment.

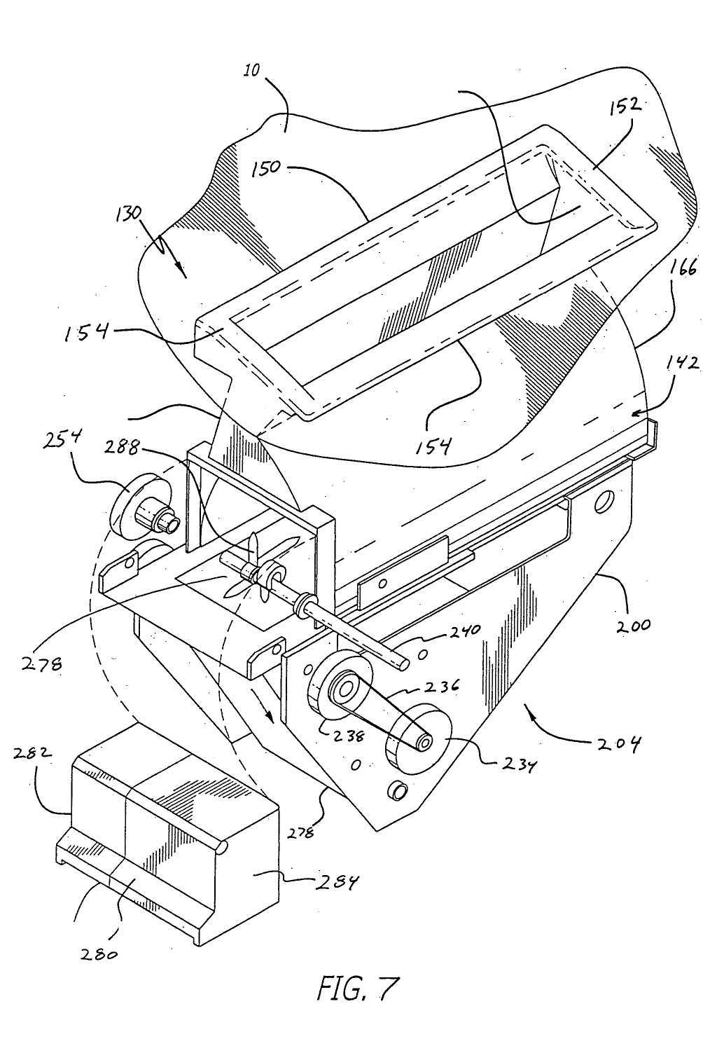

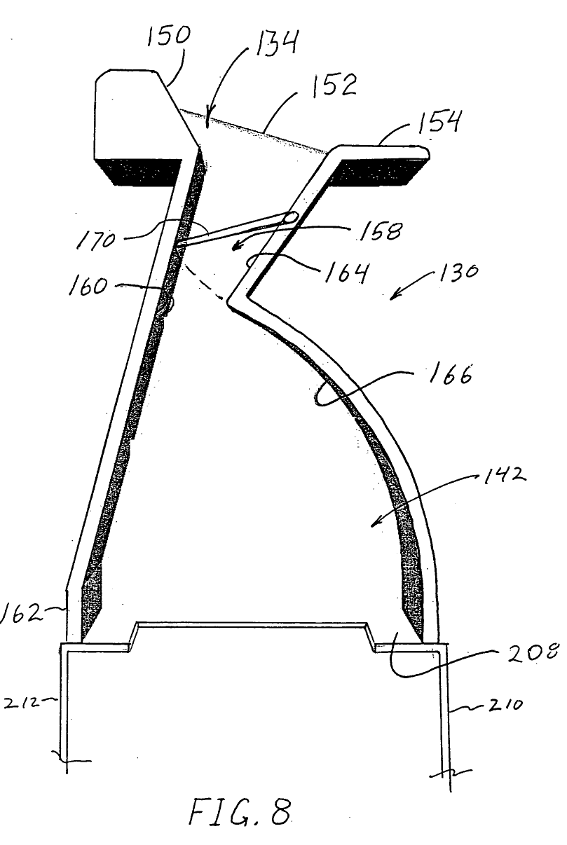

FIG. 7 illustrates a perspective view of an alternative design for a note feeder 130 adapted to receive at least one note from the top side of a table 10 and provide the at least one note to the validator assembly 30 located underneath the table 10. The note feeder 130 may be used in a variety of applications such as in a check out counter of a retail store as well as in the gaming industry. In a gaming industry, the note feeder 130 may be provided at the edge of the gaming table 10 next to where a dealer may stand or positioned at the location of the drop slot. The note feeder 130 includes a note chute 132 that defines an opening or mouth 134 designed to receive a stack of notes which are to be escrowed and fed into the validator assembly 30 along a predetermined orientation. The note feeder 130 passes the notes inserted through the mouth 134 to an escrow reservoir 142 located underneath the top of the table 10.

FIG. 7 also illustrates a bracket 200 adapted to couple the note feeder 130 to a transportation assembly 202 and the validator assembly (not shown). The bracket 200 may have a top plate 208 and triangular shaped sides 210, 212 with the top plate 208 coupled to the base of the note feeder 110. The bracket 200 is configured to mount the components of the transportation assembly 202 (described more fully below) which is operative to pass notes from the escrow reservoir 142 to the validator assembly.

In most applications, the validator assembly 30 has an inlet opening that is adapted to receive notes along the narrow edge of the rectangular shape note. The validator assembly is positioned underneath the gaming table 10 and proximate to the bottom of the chute 132 of note feeder 130, to receive the at least one note along a predetermined orientation, i.e., along the narrow edge of the rectangular shape note. A transportation assembly 202 guides each of the notes from escrow reservoir 142 along the predetermined orientation so that the narrow edge of the note is fed into the inlet opening of the validator assembly 30.

The top of the mouth 134 of the note feeder 130 may be substantially flush with the top surface of the table 10 and configured to receive a stack of notes inserted along an elongated edge of the rectangular shaped note. The note chute 132 defining the mouth 134 may have a generally rectangular shape defined by sides 150, 152, 154 and 156. The edge 154 may be substantially flush with the top surface of the gaming table 10 to allow a dealer to slide one or more notes over the edge 154 and into the mouth 134. The sides 150, 152, and 156 around the mouth 134 may be slightly elevated relative to the surface of table 10. The raised sides 150, 152 and 156 may act as a “spill-guard” for beverages which may be accidentally spilled on the table 10. Side 150 may include a display 168 operative as discussed above with respect to display 54.

Additionally, when the dealer attempts to place or drop a stack of notes into the note feeder 130, the dealer may feel for the raised sides to find the mouth 134 of the note feeder 130. As a result, the dealer may initiate the drop transaction without losing eye contact with the players at the table.

Before inserting one or more notes into the mouth 134 of the note feeder 130, a dealer may organize a stack of rectangular shape notes so that the elongated edges of the notes are aligned relative to each other. The dealer may then insert the stack of notes along an elongated leading edges of the notes into the mouth 134. The mouth 134 of the note feeder 130 may be sized to allow a dealer to insert a plurality of notes, such as forty notes, into the mouth 134 of the note feeder 130. The sides defining the note chute 132 may narrow gradually downward from the top surface of the gaming table 10.

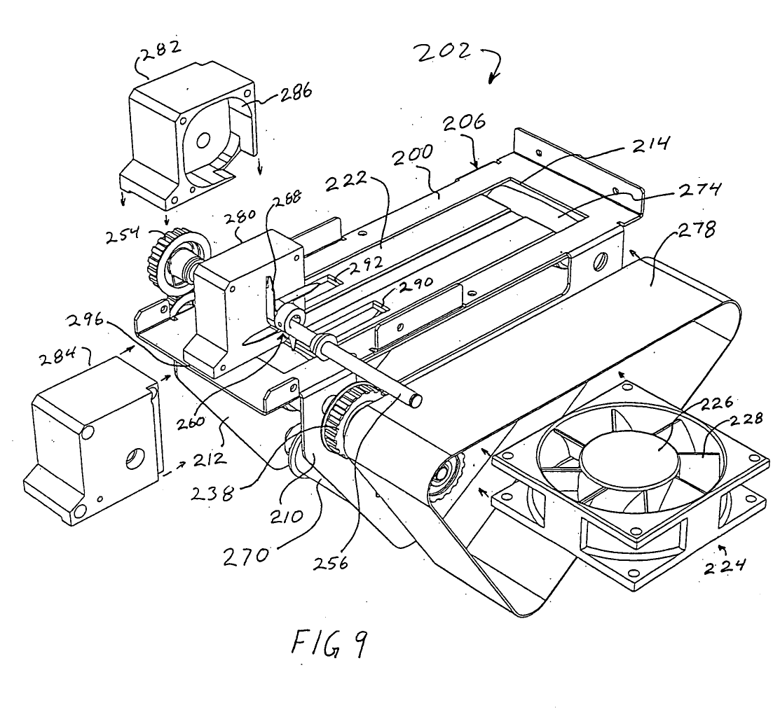

FIG. 8 shows a partial cross-sectional view of the note chute 132. At the top of the note chute 132 is the mouth 134 defined by sides 150, 152 and 154. The mouth 134 opens to a throat 158 defined by continuations of sides 152 and the removed side 156. Side 150 of the mouth transitions to a backwall 160 at he upper most part of the throat. The backwall 160 extends downward, preferably at a small angle to a line perpendicular to the surface of table 10, and transitions to a basewall 162. Side 154 of the mouth of 134 transitions to a frontwall 164 at the uppermost part of the throat 158. The frontwall 164 is slanted at a sharper angle toward the backwall 160 whereby the width of throat 158 gradually becomes narrower. As depicted in the exemplary design, the frontwall 164 extends about one-fourth to one-third of the height of the backwall 160. At the bottom edge of the frontwall 164 is a transition to an arched wall 166 which extends in an arch away from the backwall and down, terminating at a lower edge spaced apart from the lower edge of the basewall 162. The lower edges of sides 152, 154, basewall 162 and archedwall 166 all rest on the upper surface of bracket 200. The lower portion of the backwall 160, basewall 162 and arched wall 166, together with sides 152 and 156, and the top of bracket 200, define the escrow reservoir 142.

With the construction depicted in FIG. 8 and described above, one or a stack of notes inserted into the mouth 134 will be directed into the throat 168 and, constrained by backwall 160 and directed rearward by frontwall 164, the notes wall fall to land on bracket 200 with an edge proximate the basewall 162. The note or notes will then pivot and fall sideways toward arched wall 166 and land on flat at the bottom of escrow reservoir 142.

The note feeder 130 may include a gate or valve 170 within the throat 158. The valve 170 allows one or more notes to pass through the note chute 132 and fall toward the base of the escrow reservoir 142 and therefrom processed before allowing a subsequent set of notes to pass through the note chute 132. This way two sequential sets of notes are not counted together or jam the note feeder. In a gaming operation, once a dealer inserts a stack of notes through the mouth 134 of the note feeder 130, the valve 170 may close the note chute 132 for a predetermined period of time to allow the stack of notes to pass to the validator assembly before allowing a second set of notes to pass through the note chute 132. The valve 170 may be pivotally coupled to either the backwall 160 or frontwall 164 of the throat 158. In addition, the valve 170 may operate to prevent notes inserted through the mouth 134 from being retrieved out of the mouth 134 once the notes have passed through the note chute 132.

With the note feeder 130 of the present invention, a stack of notes may be dropped into the mouth 134 with one hand, while leaving the other hand free to perform other functions. For some games played in a casino environment, such as black jack or poker, the dealer may not be allowed to put the deck of cards onto the gaming table other than to shuffle the cards with both hands. The design of the note feeder 130 allows a dealer to deal black jack or poker in a casino environment with one hand, while performing the drop transaction with the other hand.

The inner surfaces of the note chute 132 may be coated with a variety of materials to minimize the friction between the note and the internal surfaces of the note chute 132. This way, notes may fall through the note chute 132 and into the escrow reservoir 142 with minimal resistance. When a drop transaction is performed by the dealer, the stack of notes may fall through the note chute 132 and into the escrow reservoir 142 due to gravity. Alternatively, mechanisms such as a pneumatic or vacuum source or mechanical spring systems may be provided within the escrow reservoir 142 to aid transport and proper orientation of the notes into the escrow reservoir 142.

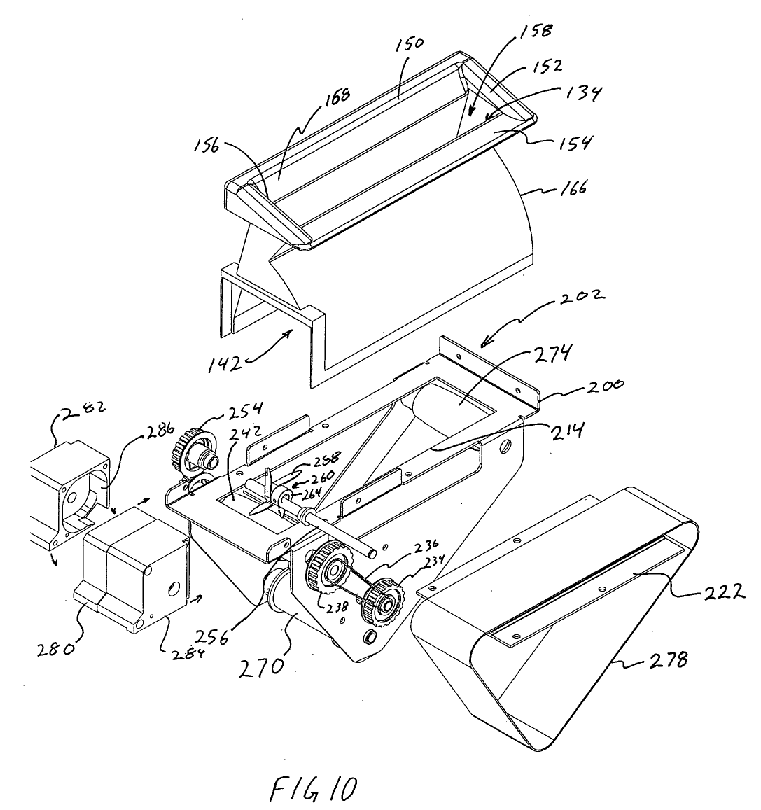

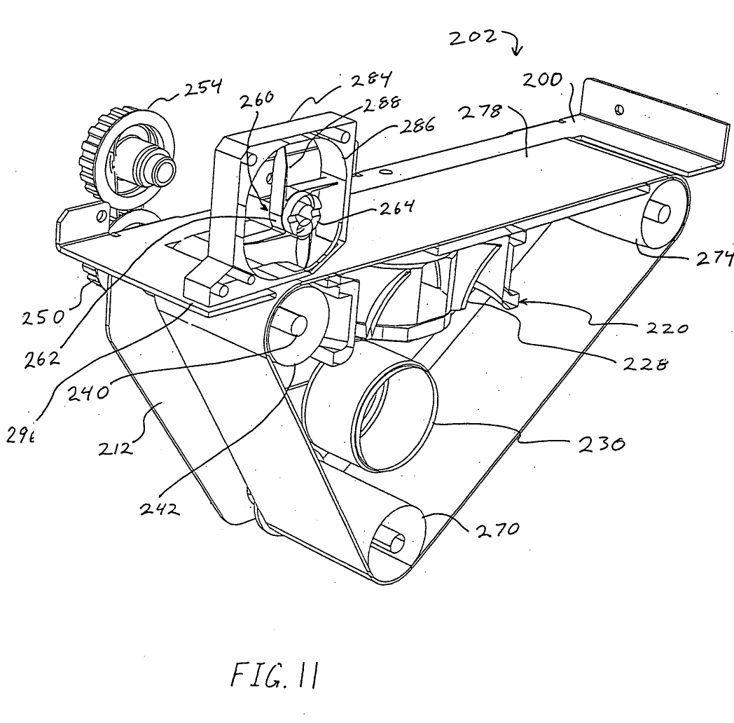

FIGS. 9 to 11 illustrate the main components of the transportation assembly 202 adapted to transport the notes from the escrow reservoir 142 to the inlet opening of the validator assembly 30. Once the notes are dropped into the mouth 134 of the note feeder 130, the escrow reservoir 142 may serve as a temporary storage for the notes while waiting to be fed into the validator assembly 30. The validator assembly 30 then validates the notes and sends the notes to the cash box 40 for stacking. With the notes laying flat on the base of the escrow reservoir 142, each of the notes may be fed sequentially from bottom to top of the notes into the validator assembly 30 by the transportation assembly 202.

The transportation assembly 202 for the note feeder 130 is depicted in the perspective and cut away and exploded views of FIGS. 9 through 11. The transportation assembly 202 is built on a bracket 200 having a top plate 208 and downward depending generally triangularly shaped side plates 210 and 212. The top plate 208 has a cutout 214. The transportation assembly 202 includes a fan bracket assembly 220 which includes a fan bracket 222 and a fan assembly 224. The fan assembly 224 includes a fan motor 226 and fan blades 228. The fan bracket assembly 220 includes the fan bracket 222 having a generally planer surface which is mounted to the bottom side of the top plate 208 of mounting bracket 206, spanning the cutout 214 yet leaving openings at opposite ends of the fan bracket 222.

The transportation assembly 202 also includes a motor 230 connected via a shaft 232 to drive a pulley 234. A belt 236 wraps around the pulley 234 so as to drive a second pulley 238. The second pulley 238 is mounted on a shaft 240 extending all the way through both side plates 210, 212 of the mounting bracket 206. A belt drive roller 242 is mounted on shaft 240 in the location positioned between the respective side plates 210 and 212. At the opposite side of the mounting bracket 206, the shaft 240 extends outward to drive a timing pulley 250 which is connected via a timing belt 252 to drive a driven pulley 254 connected to a shaft 256 that extends back through side plate 212 and extending to the opposite side plate 210 of the mounting bracket 206. A hub assembly 260 is mounted at a mid point on the shaft 256. The hub assembly 260 includes a hub 262 and a hub plates 264.

A bottom belt roller 270 is mounted at the lower portion of the side plates 210 and 212 on a shaft 272 secured by bushings at the lower corners of the triangular side plates 210 and 212. A rear belt roller 274 is mounted on a shaft 276 and mounted in bushings at the rear corners of triangular side plates 210 and 212. A conveyor belt 278 is configured to wrap around the belt drive roller 242, bottom belt roller 270 and rear belt roller 274 and to extend up through the openings formed at the respective ends of the fan mounting bracket 222 and the mounting bracket top plate 208, whereby the belt runs over the top surface of the fan bracket 222 driven by belt drive roller 242.

At the forward edge of the transportation assembly 202 is the picker assembly 202. The picker assembly includes a center section 280, left side 282 and right side 284. Within at least one of the sides 282 or 284 there is a cavity 286 which accommodates a picker wheel 298. The picker wheel 288 incorporates the hub 262 and the blades 264. These components are mounted on the shaft 256 so as to rotate in the opposite direction as the direction that the conveyor belt 268 rotates when a bill is being transported out of the reservoir 142 by the transportation assembly 202. The counter rotation of the hub blades 264 prevents multiple bills from passing from the reservoir 142 stacked one on top of the other.

As noted above, the fan bracket assembly 220 includes a fan bracket 222 forming a plate over which the conveyor belt 278 traverses. The lowermost note in the reservoir 142 lays atop the upper surface of the conveyor belt 278. The fan bracket 222 includes slots 290, 292 and the conveyor belt 278 is made from a porous material whereby the note lying atop the conveyor belt 278 is sucked down towards the belt by the operation of the fan assembly 224 and air passing through the openings 290, 292 of the fan bracket 222. The fan motor 226 and belt drive motor 230 are both electrically connected to the validator 30 to obtain power and processing control signals therefrom. Thus, when the transportation assembly 202 is activated, the fan motor 226 and belt drive motor 230 are both powered, one to adhere notes to the conveyor belt 278 and the second to drive the conveyor belt 278, and the validator 30 is also activated to accept and process the notes being provided.

The transportation assembly 202 operates to selectively feed one note at a time from the escrow chamber 142 across the top of the conveyor belt 278 towards an outlet slot 296 so that the note may pass to the intake slot of the validator 30. The motor 230 drives the shaft 232 and thereby the timing pulley 234 which in turn drives the belt 236 driving the timing pulley 238 and shaft 240. The belt drive roller 242 mounted on shaft 240 frictionally engages the conveyor belt 278 thereby driving the conveyor belt 278. The opposite end of shaft 240 also rotates, rotating the timing pulley 250 and the timing belt 252 to drive the driven pulley 254 and shaft 256. The rotation of shaft 256 is counter-rotating with respect to the shaft 240 on which the belt drive roller 242 is mounted and so the shaft 256 having the hub assembly 260 and more particularly the hub blades 264 rotates in a counter direction with respect to the direction of the movement of the conveyor belt 268. By this configuration, one note at a time is extracted from the reservoir of 142 to be sequentially fed into the validator 30, and the transportation assembly 202 can rapidly move a stack of notes from the escrow chamber 142 to the validator 30.

In the validator 30, as discussed above, information concerning the authenticity and denomination of each note is passed to the validator processor 50 (discussed above) which is also preferably connected to a central computer or server of the casino. Upon receipt of a note or a series of notes and determination of their authenticity, a signal is sent to the casino processor or server signifying receipt as well as the denomination of the notes. The value of the notes accepted by the validator assembly 30 can also be displayed individually, sequentially or cumulatively totaled on the display panel 158, which is electrically interconnected to the validator processor 50.

The bracket 200 may be pivotally coupled to the note feeder 130 such that the bracket 200 can be swing open to provide access to the escrow reservoir of the note feeder 130. A lock assembly may be provided to fix the note feeder assembly 130 in place to the bracket 200.

From the foregoing detailed description, it will be evident that there are a number of changes, adaptations and modifications of the present invention which come within the province of those skilled in the art. The scope of the invention includes any combination of the elements from the different species or embodiments disclosed herein, as well as subassemblies, assemblies, and methods thereof. However, it is intended that all such variations not departing from the spirit of the invention be considered as within the scope thererof.

1. A note feeder for a note validator assembly, the note feeder comprising:
a note chute defining a mouth to receive a stack of notes inserted edge first;
an escrow reservoir configured to receive notes from said note chute rotate, and escrow the notes in a predetermined orientation; and
a transportation assembly to sequentially transport notes from said escrow reservoir to the validator assembly.

2. The note feeder of claim 1, wherein the transportation assembly includes:
a motor driven conveyor belt adapted to notes to the validator assembly.

3. The note feeder of claim 1, wherein the escrow reservoir has an angled backwall and arched wall spaced apart so as to pivot notes on a leading edge thereof so as to fall to the bottom of said escrow reservoir into said predetermined orientation.

4. The note feeder of claim 3, wherein the escrow reservoir is mounted over a fan assembly configured to assist notes to fall towards the base of the reservoir into the predetermined orientation.

5. The note feeder of claim 1, wherein said note chute defining said mouth is defined by sides at least one of which is adapted to be elevated above a top surface of a table.

6. The note feeder of claim 6, wherein at least one of said sides is mounted flush with a top of the table.

7. The note feeder of claim 1, wherein the mouth has a rectangular configuration having a length at least equal to the length of standard currency and a width sufficient to receive a stack of at least five standard currency thickness notes therethrough.

8. The note feeder of claim 7, wherein the mouth has a width sufficient to receive a stack of at least 40 standard currency notes.

9. The note feeder of claim 1, wherein at least one side of said note chute incorporates a display to indicate the value of notes received by the validator assembly.

10. The note feeder of claim 1, further including a valve within the note chute to close the note chute for a predetermined time after passage of a stack of notes to allow the notes to pass to the validator assembly before allowing a subsequent set of notes to pass through the note chute.

11. The note chute of claim 1, wherein the note chute is removable from a transportation assembly to allow access to the escrow reservoir.

12. A note validation assembly adapted to receive at least one note from a top side of a table and pass the at least one to a validator assembly located at a bottom side of the table, the note validation assembly comprising:
a note chute defining a mouth configured to receive a stack of notes from the top side of the table;
an escrow reservoir adapted to receive and escrow the notes located at the bottom side of the table, said escrow reservoir having a base to store notes along a predetermined orientation; and
guiding surfaces defining said escrow reservoir to guide the notes to fall towards the base of the reservoir along the predetermined orientation.

13. The validator assembly of claim 12, further comprising:
a transportation assembly to sequentially process notes; and
a bill validator assembly to validate said notes.

14. The validator assembly of claim 13, further comprising: a display mounted into a side of said note chute defining said mouth, said display being electronically connected to said bill validator assembly.

15. A table mounted note validating assembly adapted to authenticate and store at least one note in a secure area, the assembly comprising:
a note feeder built in the top side of the table and adapted to receive a plurality of notes;
an escrow reservoir underneath the table adapted to store the plurality of notes along a predetermined orientation;
a validator assembly underneath the table having an inlet opening adapted to receive each of the plurality of notes along the predetermined orientation, the validator assembly capable of authenticating each of the plurality of notes and storing the authenticated notes; and
a transportation system adapted to transport each of the plurality of notes from the escrow reservoir to the inlet opening of the validator assembly.

16. The table according to claim 15, wherein the table is a gaming table.

17. The table according to claim 15, wherein the table is a cashier table.

18. A method of authenticating a plurality of notes and storing the plurality of notes underneath a table, the method comprising:
receiving a plurality of notes through a mouth formed within a top side of a table;
passing the plurality of notes to an escrow reservoir underneath the table;
guiding the plurality of notes to fall into the escrow reservoir along a predetermined orientation; and
sequentially transporting each of the plurality of notes from the reservoir to a validator assembly along the predetermined orientation for authenticating the plurality of notes and storing the authenticated notes.

19. A note processing system capable of receiving a stack of notes at a top side of a table and passing the notes to a validator assembly located at a bottom side of the table, the note processing system comprising:
a note feeder adapted to receive at least one note from the top side of the table and store the at least one note at the bottom side of the table in a predetermined orientation;
a validator assembly located at the bottom side of the table, the validator assembly having an inlet opening adapted to receive the at least one note and authenticate the at least one note; and
a transportation system adapted to transport the at least one note from the note feeder to the inlet opening of the validator assembly along the predetermined orientation.

20. The note processing system according to claim 19, wherein the note feeder includes:
a mouth substantially flush with the top side of the table and adapted to receive the at least one note;
a reservoir adapted to house the at least one note at the bottom side of the table;
a chute between the mouth and the reservoir, the chute adapted to pass the at least one note from the mouth to the reservoir; and
a guiding surface adapted to assist the at least one note to fall into the reservoir and align in the predetermined orientation.
